(19) United States
(12) Patent Application Publication
(10) Pub. No.: US 2022/0085561 A1
(43) Pub. Date: Mar. 17, 2022

(54) METHOD OF MANUFACTURING FEMALE TERMINAL

(71) Applicant: Yazaki Corporation, Tokyo (JP)

(72) Inventors: Hiroshi FUJITA, Shizuoka (JP); Hideki Mizuno, Shizuoka (JP)

(73) Assignee: Yazaki Corporation, Tokyo (JP)

(21) Appl. No.: 17/471,320

(22) Filed: Sep. 10, 2021

(30) Foreign Application Priority Data
Sep. 11, 2020 (JP) 2020-152543

(51) Int. Cl. H01R 43/02; H01R 4/02

(52) U.S. Cl. CPC H01R 43/0207; H01R 43/048; H01R 4/023

(57) ABSTRACT

A method of manufacturing a female terminal includes: (i) cutting a portion located at a side of one end of a tubular member into an L-shape when viewed from a direction intersecting with an axial direction of the tubular member to form an electric wire connection portion at the side of the one end of the tubular member and form as a terminal contact portion a portion remaining in a tubular shape at a side of the other end of the tubular member; and (ii) electrically connecting a core wire exposed from an end of an electric wire to the electric wire connection portion.

### CROSS-REFERENCE TO RELATED APPLICATIONS

The present application is based on, and claims priority from Japanese Patent Application No. 2020-152543, filed on Sep. 11, 2020, the entire contents of which are incorporated herein by reference.

### TECHNICAL FIELD

The disclosure relates to a method of manufacturing a female terminal.

### BACKGROUND

As a method of manufacturing a crimp terminal having one end with a cylindrical crimping portion and the other end with a plate-like connection portion, there has been known one disclosed in Patent Document 1 (JP6326320). In the method of manufacturing the crimp terminal disclosed in Patent Document 1, the crimp terminal is manufactured by hollowing a solid cylindrical member at one end of the solid cylindrical member to form a bottomed cylindrical electric wire insertion hole, and by performing press rolling of the solid cylindrical member into a plate shape at the other end of the solid cylindrical member to form a connection portion of a battery terminal.

### SUMMARY

However, the conventional method of manufacturing the crimp terminal requires the hollowing of the solid cylindrical member to form the electric wire insertion hole, which increases a manufacturing cost. In addition, since a bottomed cylindrical portion is used as the electric wire insertion hole, a plating solution stagnates when this portion is plated, which prevents a plated layer from being uniformly formed on this portion.

The disclosure has been made in view of such a conventional problem, and it is an object of the disclosure to provide a method of manufacturing a female terminal that can reduce a manufacturing cost to lower a cost of production and can uniformly form a plated layer over an entire circumference of the female terminal excluding an electric wire.

According to an embodiment, there is provided a method of manufacturing a female terminal including: cutting a portion located at a side of a first end of a tubular member into an L-shape when viewed from a direction intersecting with an axial direction of the tubular member to form an electric wire connection portion at the side of the first end of the tubular member and form as a terminal contact portion a portion remaining in a tubular shape at a side of a second end of the tubular member, wherein a male terminal is to be inserted in the terminal contact portion; and electrically connecting a core wire exposed from an end of an electric wire to the electric wire connection portion.

According to an embodiment, the method further includes plating an entire circumference of a portion remaining in a quarter tubular shape at the side of the first end and the portion remaining in the tubular shape at the side of the second end after cutting into the L-shape, to form a plated layer.

According to an embodiment, the core wire of the electric wire is electrically connected to the electric wire connection portion formed into an arc shape which is a portion remaining in a quarter tubular shape at the side of the first end after cutting into the L-shape, by ultrasonic bonding.

According to an embodiment, the method further includes: crushing a portion remaining in an quarter tubular shape at the side of the first end after cutting into the L-shape, to form the electric wire connection portion; and plating an entire circumference of the electric wire connection portion and the portion remaining in the tubular shape at the side of the second end after cutting into the L-shape, to form a plated layer.

According to an embodiment, the method further include crushing a portion remaining in an quarter tubular shape at the side of the first end after cutting into the L-shape, to form the electric wire connection portion, wherein the core wire of the electric wire is electrically connected to the electric wire connection portion by ultrasonic bonding.

According to an embodiment, it is possible to provide a method of manufacturing a female terminal that can reduce a manufacturing cost to lower a cost of production and can uniformly form a plated layer over an entire circumference of the female terminal excluding an electric wire.

### BRIEF DESCRIPTION OF THE DRAWINGS

FIG. 1 is a perspective view of a round tube member used in a method of manufacturing a female terminal according to a first embodiment.

FIG. 2 is a side view illustrating a state where a portion located at a side of one end of the round tube member is cut into an L-shape to form a quarter round tube portion according to the first embodiment.

FIG. 3 is a perspective view of the round tube member with the quarter round tube portion according to the first embodiment.

FIG. 4 is a side view illustrating a state before a core wire of an electric wire is connected to the quarter round tube portion according to the first embodiment serving as an electric wire connection portion.

FIG. 5 is a side view illustrating a state where the core wire of the electric wire is connected to the electric wire connection portion according to the first embodiment.

FIG. 6 is a side view illustrating a state where a portion located at a side of one end of a round tube member used in a method of manufacturing a female terminal according to a second embodiment, is cut into an L-shape to form a quarter round tube portion.

FIG. 7 is a perspective view illustrating a state where the quarter round tube portion according to the second embodiment is crushed.

FIG. 8 is a side view illustrating a state before a core wire of an electric wire is connected to a portion serving as an electric wire connection portion where the quarter round tube portion according to the second embodiment is crushed.

FIG. 9 is a side view illustrating a state where the core wire of the electric wire is connected to the electric wire connection portion according to the second embodiment.

### DETAILED DESCRIPTION

A method of manufacturing a female terminal according to various embodiments will be described below with reference to the accompanying drawings. Note that the dimensional ratios in the drawings are exaggerated for convenience of explanation and may differ from the actual ratios.

### First Embodiment

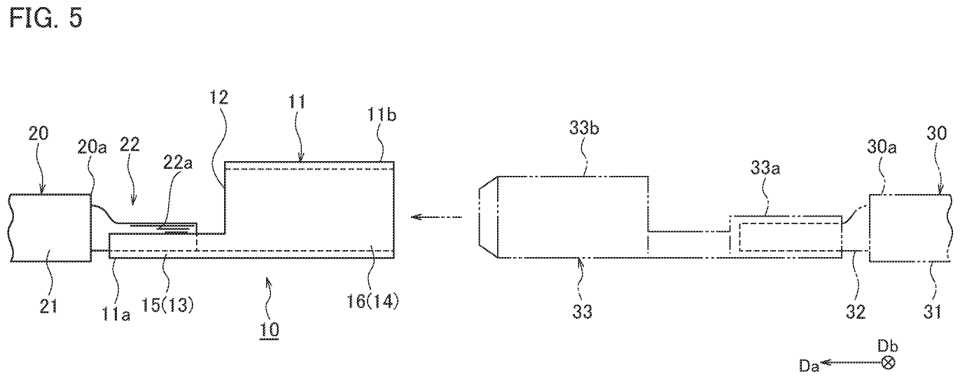

As illustrated in FIG. 5, a female terminal 10 according to the first embodiment includes a round tube member 11 (tubular member) with a portion to which cutting into an L-shape when viewed from a direction Db vertically intersecting with an axial direction Da of the round tube member 11 is applied. The round tube member 11 with the portion to which the cutting into an L-shape is applied is also referred to as a cutting-applied round tube member 11. The female terminal 10 has an electric wire connection portion 15 at a side of one end 11a (first end) of the cutting-applied round tube member 11. The female terminal 10 has a terminal contact portion 16 at a side of the other end 11b (second end) of the cutting-applied round tube member 11. A core wire 22 exposed from an end 20a of an electric wire 20 is electrically connected to the electric wire connection portion 15. A male terminal 33 crimped to an end 30a of an electric wire 30 is to be inserted in the terminal contact portion 16. The female terminal 10 is a female terminal with an electric wire.

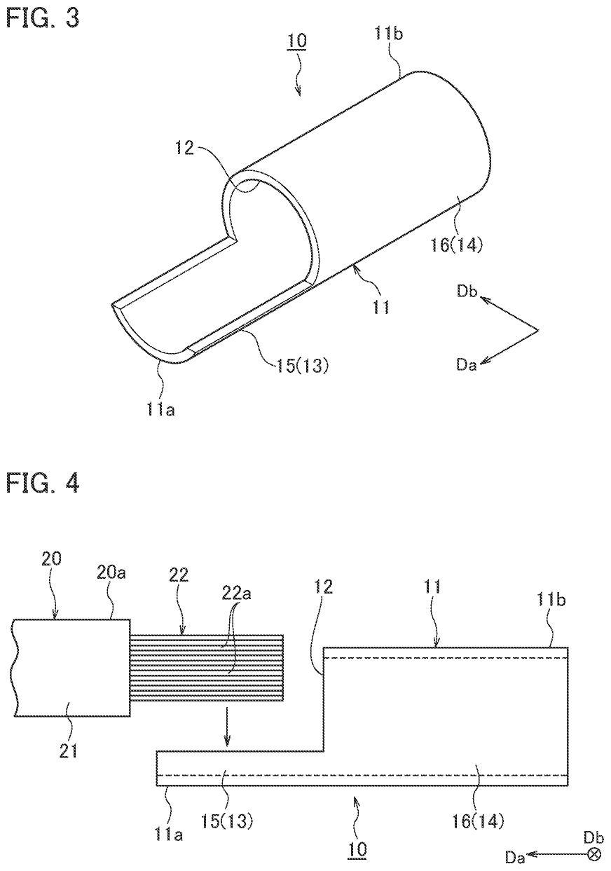

As illustrated in FIGS. 3 and 4, a quarter round tube portion 13 (a quarter tubular portion) is formed at the side of the one end 11a (first end) of the round tube member 11. The quarter round tube portion 13 is also referred to as a portion remaining in a quarter tubular shape at the side of the one end 11a after cutting into an L-shape. The electric wire connection portion 15 is formed at the side of the one end 11a of the round tube member 11 by leaving the quarter round tube portion 13 in its original shape without crushing the quarter round tube portion 13. The terminal contact portion 16 is formed at the side of the other end 11b (second end) of the round tube member 11 by leaving a round tube shape portion 14 (a tubular portion), which is a remaining portion of the round tube member 11 excluding the quarter round tube portion 13, in its original shape. The round tube shape portion 14 is also referred to as a portion remaining in a tubular shape at the side of the other end 11b after cutting into an L-shape. A cylindrical tab portion 33b of the male terminal 33 is to be inserted in the terminal contact portion 16 to contact the terminal contact portion 16.

As illustrated in FIGS. 4 and 5, the electric wire 20 has an insulation coating 21 and the core wire (conductor) 22 including a plurality of strands 22a twisted together. The core wire 22 is covered with the insulation coating 21. The core wire 22, which is exposed by peeling off the insulation coating 21 on a side of the end 20a of the electric wire 20, is electrically connected to the electric wire connection portion 15 by ultrasonic bonding. Note that as specific materials of the core wire 22, copper or a copper-based copper alloy, or aluminum or an aluminum-based aluminum alloy can be mentioned.

As illustrated in FIG. 5, the electric wire 30 has an insulation coating 31 and the core wire (conductor) 32 including a plurality of strands twisted together. The core wire 32 is covered with the insulation coating 31. A crimping portion 33a of the male terminal 33 is crimped and connected to the core wire 32, which is exposed by peeling off the insulation coating 31 on a side of the end 30a of the electric wire 30. The cylindrical tab portion 33b of the male terminal 33 is inserted in the cylindrical terminal contact portion 16 of the female terminal 10 to be electrically connected to the terminal contact portion 16 of the female terminal 10. Note that as specific materials of each of the core wire 32 and the male terminal 33, copper or a copper-based copper alloy, or aluminum or an aluminum-based aluminum alloy can be mentioned.

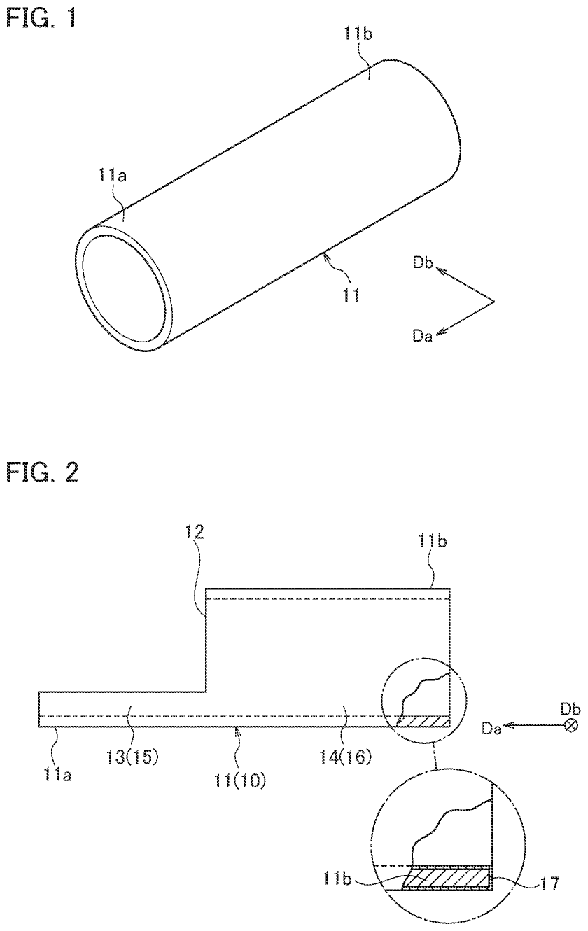

Next a method of manufacturing of the female terminal 10 will be describe along FIGS. 1 to 4.

First of all, the round tube member 11 as the tubular member is prepared, as illustrated in FIG. 1. The round tube member 11 is formed into a cylindrical shape with a perfect circle and is made of a material with excellent conductivity such as a metal. The specific materials of the round tube member 11 include a conductive metal tube such as copper or a copper-based copper alloy, or aluminum or an aluminum-based aluminum alloy. Furthermore, the round tube member 11 may be made of a member produced by forming a metal plate into a cylindrical shape by press forming.

Although the round tube member 11 formed into a cylindrical shape is used as the tubular member as described above, a shape of the tubular member is not limited to the cylindrical shape. The shape of the tubular member may be an elliptical tube shape or a square tube shape.

Next, as illustrated in FIG. 2, a portion located at the side of the one end 11a of the round tube member 11 is cut into an L-shape when viewed from the direction Db vertically intersecting with the axial direction Da of the round tube member 11, to form the quarter round tube portion 13 that serves as the electric wire connection portion 15. Due to the cutting, the terminal contact portion 16 in which the cylindrical tab portion 33b of the male terminal 33 is to be inserted, is formed at the side of the other end 11b of the round tube member 11 by leaving the round tube shape portion 14, which is the remaining portion of the round tube member 11 excluding the quarter round tube portion 13, in its original shape. Note that an L-shaped notch is indicated by a reference sign 12 in FIG. 2.

Then, as illustrated in FIG. 2, the entire circumference of the quarter round tube portion 13 (electric wire connection portion 15) and the round tube portion 14 (terminal contact portion 16), which are left after cutting into an L-shape, are plated to form a plating layer 17 such as a tin plating layer.

As illustrated in FIG. 3, the quarter round tube portion 13 remaining after cutting in an L-shape becomes the electric wire connection portion 15 in its original shape. Then, as illustrated in FIG. 4, the core wire 22 exposed from the end 20a of the electric wire 20 is electrically connected to the electric wire connection portion 15 which is formed in a quarter round shape, that is, an arc shape when viewed from the axial direction Da of the round tube member 11, by ultrasonic bonding, thereby completing the female terminal 10 with the electric wire illustrated in FIG. 5.

In the method of manufacturing of the female terminal 10 according to the first embodiment, the quarter round tube portion 13, which is left at the side of the one end 11a of the round tube member 11 after cutting the portion located at the side of the one end 11a of the round tube member 11 into an L-shape, is used as the electric wire connection portion 15. The round tube portion 14, which is left at the side of the other end 11b of the round tube member 11 after cutting the portion located at the side of the one end 11a of the round tube member 11 into an L-shape, is used as the terminal contact portion 16. Therefore, it is not necessary to perform the conventional hollowing of a solid cylindrical member.

Further, the round tube portion 14, which is left at the side of the other end 11b of the round tube member 11 and is formed into a non-bottomed hole, is used as the terminal contact portion 16. This configuration allows a plating solution to flow without stagnating when this portion is plated. In other words, by cutting the round tube member 11 into an L-shape and then leaving the round tube member 11 without crushing it, the plating solution can easily circulate around the outside, inside, front and back of the round tube member 11, which allows additives in the plating solution to be evenly applied.

Furthermore, as illustrated in FIG. 3, when viewed from the axial direction Da of the round tube member 11, a cross-sectional surface of the quarter round tube portion 13, which is left at the side of the one end 11a of the round tube member 11 after cutting the portion located at the side of the one end 11a of the round tube member 11 into an L-shape, is formed into an arc-shape. In other words, the arc-shaped portion, which is left at the side of the one end 11a of the round tube member 11 after cutting the portion located at the side of the one end 11a of the round tube member 11 into an L-shape, becomes the electric wire connection portion 15. Therefore, as illustrated in FIG. 4, by ultrasonically connecting the core wire 22 of the electric wire 20 on the arc-shaped electric wire connection portion 15, which is the quarter round tube portion 13, the round tube member 11 and the electric wire 20 can be electrically connected to each other while the misalignment of the round tube member 11 and the electric wire 20 is easily and surely prevented.

Thus, it is not necessary to perform the conventional hollowing of a solid cylindrical member, which reduces a manufacturing cost of the female terminal 10 to lower a cost of production. The round tube member 11 is plated after the round tube member 11 is cut into an L-shape when viewed from the direction Db vertically intersecting with the axial direction Da of the round tube member 11, which uniformly forms a plated layer over an entire circumference of the round tube member 11.

### Second Embodiment

A female terminal 10A according to a second embodiment differs from the female terminal 10 according to the first embodiment in that the quarter round tube portion 13, which is left at the side of the one end 11a of the round tube member 11 after cutting the portion located at the side of the one end 11a of the round tube member 11 into an L-shape, is crushed to form a flat electric wire connection portion 15A. Since other portions are the same as those of the first embodiment, the same reference signs are attached to the same portions and the detailed descriptions are omitted.

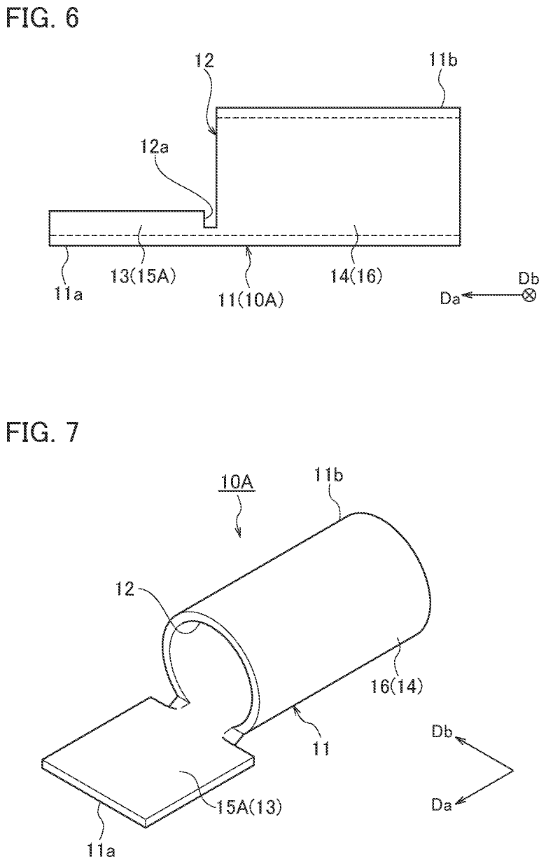

As illustrated in FIG. 6, in the female terminal 10A, when the portion located at the side of one end 11a of the round tube member 11 is cut into an L-shape, a pair of slits 12a extending to the vicinity of a bottom of the round tube member 11, is formed on both sides of the notch 12. Then, as illustrated in FIG. 7, the quarter round tube portion 13 of the round tube member 11 is crushed from above downward to form the flat electric wire connection portion 15A. For example, a crushing direction is a normal direction bisecting a quarter of a circle visible as the quarter round tube portion 13, viewed from the axial direction Da of the round tube member 11.

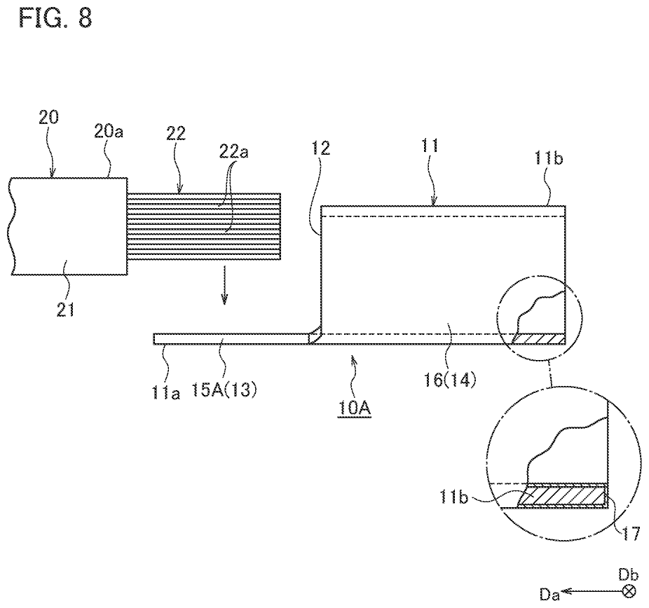

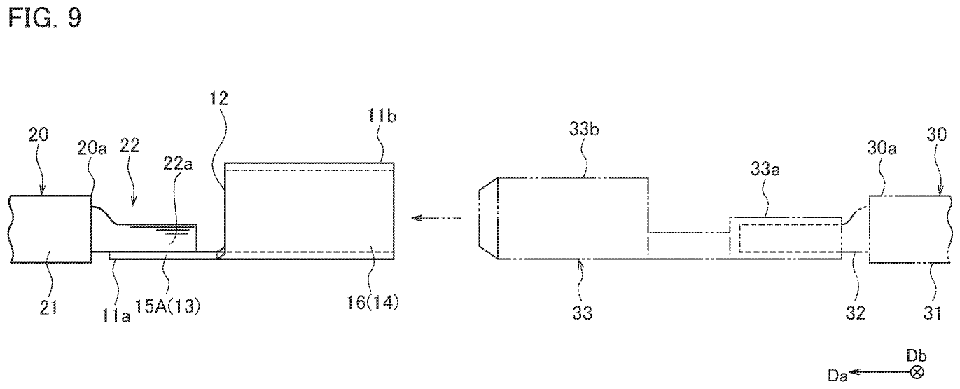

Next, as illustrated in FIG. 8, after crushing, the entire circumference of the flat electric wire connection portion 15A and the terminal contact portion 16, which is the round tube portion 14, is plated to form the plating layer 17 such as a tin plating layer. Then, the core wire 22 of the wire 20 is electrically connected on the flat electric wire connection portion 15A by ultrasonic bonding. This produces the same action and effect as the first embodiment, and completes the female terminal 10A with an electric wire illustrated in FIG. 9.

Although the first and second embodiments are described above, the disclosure is not limited to these. Various modifications are possible within the scope of the gist of the disclosure.

For example, in the first and second embodiments, the portion which is left at the side of the one end 11a of the round tube member 11 after cutting the portion located at the side of the one end 11a of the round tube member 11 into an L-shape, is formed into a quarter round tube shape (quarter tubular shape). The portion may be formed into a half round tube shape (half tubular shape).

In the first and second embodiments, as the tubular member, the cylindrical female terminals 10, 10A are formed using the round tube member 11. Instead of the cylindrical female terminal, a square tube female terminal may be formed using a squire tube member. In this case, the cylindrical female terminal and the square tube female terminal can be used separately according to the layout (specifications) of the connector.

Furthermore, in the first and second embodiments, the entire circumference of the round tube member 11 is plated. The entire circumference of the round tube member 11 excluding each of the electric wire connection portion 15, 15A to which the core wire 22 of the electric wire 20 is to be connected, may be plated.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of manufacturing a female terminal comprising:
cutting a portion located at a side of a first end of a tubular member into an L-shape when viewed from a direction intersecting with an axial direction of the tubular member to form an electric wire connection portion at the side of the first end of the tubular member and form as a terminal contact portion a portion remaining in a tubular shape at a side of a second end of the tubular member,
wherein a male terminal is to be inserted in the terminal contact portion; and
electrically connecting a core wire exposed from an end of an electric wire to the electric wire connection portion.

2. The method according to claim 1, further comprising
plating an entire circumference of a portion remaining in a quarter tubular shape at the side of the first end and the portion remaining in the tubular shape at the side of the second end after cutting into the L-shape, to form a plated layer.

3. The method according to claim 1, wherein
the core wire of the electric wire is electrically connected to the electric wire connection portion formed into an arc shape which is a portion remaining in a quarter tubular shape at the side of the first end after cutting into the L-shape, by ultrasonic bonding.

4. The method according to claim 1, further comprising:
crushing a portion remaining in a quarter tubular shape at the side of the first end after cutting into the L-shape, to form the electric wire connection portion; and
plating an entire circumference of the electric wire connection portion and the portion remaining in the tubular shape at the side of the second end after cutting into the L-shape, to form a plated layer.

5. The method according to claim 1, further comprising
crushing a portion remaining in a quarter tubular shape at the side of the first end after cutting into the L-shape, to form the electric wire connection portion,
wherein the core wire of the electric wire is electrically connected to the electric wire connection portion by ultrasonic bonding.
